(19) United States
(12) Patent Application Publication
(10) Pub. No.: US 2009/0238628 A1
(43) Pub. Date: Sep. 24, 2009

(54) Printing mechanism of barcode printer

(76) Inventors: Shang-Shih Kuo, Yonghe City (TW); Chin-Chuan Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,638

(22) Filed: Mar. 20, 2009

(30) Foreign Application Priority Data
Mar. 24, 2008 (TW) 097205011

(51) Int. Cl. B41J 33/00

(52) U.S. Cl. 400/223

(57) ABSTRACT

A printing mechanism is provided for a barcode printer and includes a frame, a printing head, a carbon ribbon axle, and a carbon ribbon collection axle. The frame is mounted to an upper end portion of an upper casing member. The printing head is mounted in the frame to effect printing of labels. The carbon ribbon axle is arranged in a lower portion of the frame and is located below the printing head for connecting and retaining a carbon ribbon that supplies a toner required for carrying out the printing of the labels by the printing head. The carbon ribbon collection axle is arranged in an upper portion of the frame and is located above the printing head in an arrangement that is reversed to the carbon ribbon axle to allow the carbon ribbon from the carbon ribbon axle to be rolled up in the carbon ribbon collection axle after the printing operation carried out by the printing head. The carbon ribbon from the carbon ribbon axle can be wound around and collected by the carbon ribbon collection axle in a shortest path. Thus, a printing mechanism featuring a reduced length of carbon ribbon collection path and a reduced size is provided.

### BACKGROUND OF THE INVENTION

1. Field of the Invention

The present invention relates to a printing mechanism of a barcode printer, and in particular to a printing mechanism that is applicable to a barcode printer and features the shortest carbon ribbon collection path between a carbon ribbon axle and a carbon ribbon collection axle to thereby provide a space-economic printing mechanism.

2. The Related Arts

A conventional barcode printer includes a printing mechanism functioning to effect printing operation of a barcode label inside the barcode printer. In the printing process, a toner that is required for the printing operation carried out by a printing head is supplied by a carbon ribbon in order to have desired barcodes and digits printed on the barcode labels. However, the conventional printing mechanism of the barcode printer has to collect the used carbon ribbon. Thus, a carbon ribbon collection axle must be provided inside the barcode printer. The conventional printing mechanism of the printing head is designed in such a way to ensure the positional arrangement of the carbon ribbon collection axle and the carbon ribbon can avoid the interference between carbon ribbon collection and feeding of the barcode labels. This elongates the conveyance or feeding path between the carbon and the carbon ribbon collection axle, making the overall size of the barcode printer bulky, eventually leading to trouble and inconvenience of mounting/dismounting of the carbon ribbon and also increasing the manufacturing costs of the barcode printer, as well as the amount of space occupied by the barcode printer. This is not economically efficient.

### SUMMARY OF THE INVENTION

Due to the elongated feeding path between the carbon ribbon and the carbon ribbon collection axle, the conventional printing mechanism of the barcode printer is disadvantageous in being inconvenient to recycle and clean the carbon ribbon and having a bulky size and increased costs.

Thus, the present invention is aimed to provide a printing mechanism for a barcode printer, wherein the printing mechanism comprises a frame, a printing head, a carbon ribbon axle, and a carbon ribbon collection axle, wherein the frame is mounted to an upper end portion of an upper casing member; the printing head is mounted in the frame to effect printing of labels; the carbon ribbon axle is arranged in a lower portion of the frame and is located below the printing head for connecting and retaining a carbon ribbon that supplies a toner required for carrying out the printing of the labels by the printing head; and the carbon ribbon collection axle is arranged in an upper portion of the frame and is located above the printing head in an arrangement that is reversed to the carbon ribbon axle to allow the carbon ribbon from the carbon ribbon axle to be rolled up in the carbon ribbon collection axle after the printing operation carried out by the printing head, whereby the carbon ribbon from the carbon ribbon axle can be wound around and collected by the carbon ribbon collection axle in a shortest path. Thus, a printing mechanism featuring a reduced length of carbon ribbon collection path and a reduced accommodation space is provided.

The effectiveness of the printing mechanism of a barcode printer in accordance with the present invention is that the barcode printer has a shortest path between the carbon ribbon and the carbon ribbon collection axle so that the mounting/dismounting and cleaning of the carbon ribbon is made convenient and the overall size of the barcode printer is reduced, resulting in enhanced industrial utilization of the present invention.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view showing a barcode printer in which a printing mechanism constructed in accordance with the present invention is mounted;

FIG. 2 is a perspective view similar to FIG. 1 but with a carbon ribbon axle and a carbon ribbon collection axle removed;

FIG. 3 is a perspective view illustrating a practical application of the printing mechanism of the present invention in a barcode printer; and

FIG. 4 is schematic side elevational view illustrating collection of a carbon ribbon from the carbon ribbon axle to the carbon ribbon collection axle.

### DETAILED DESCRIPTION OF THE PREFERRED EMBODIMENT

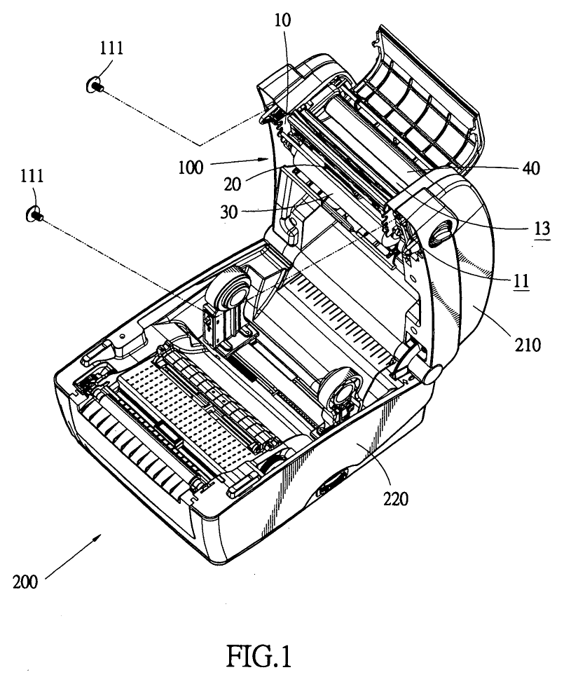

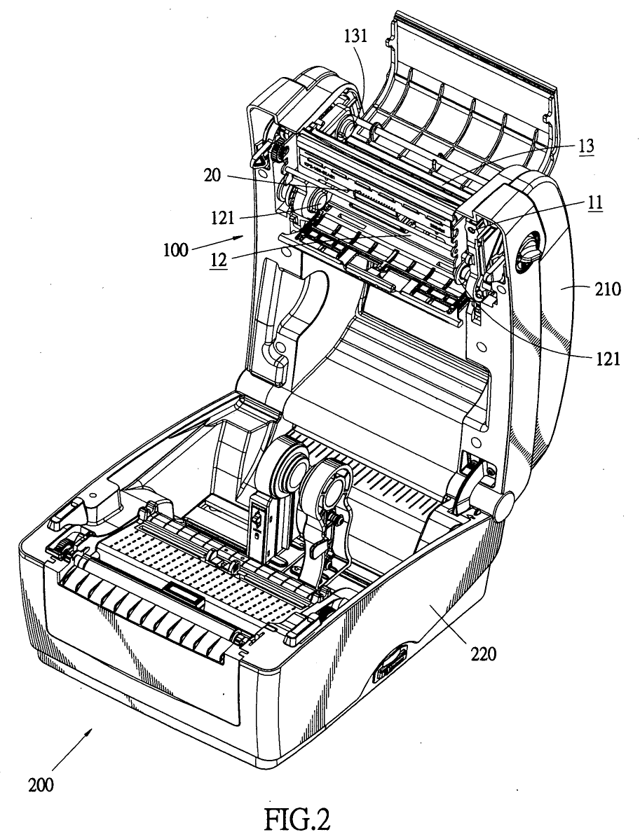

With reference to the drawings and in particular to FIGS. 1 and 2, a printing mechanism constructed in accordance with the present invention, generally designated at 100, is provided for a barcode printer, which is designated with reference numeral 200. The printing mechanism 100 comprises a frame 10 that forms at least one pair of mounting holes 11 that receives bolts 111 to fix the frame 10 to an upper end portion of an upper casing member 210 of the barcode printer 200. The frame 10 forms a first chamber 12 in a lower portion thereof and also forms a second chamber 13 in an upper portion thereof. The first chamber 12 is delimited by opposite side walls, each of which forms a carbon ribbon axle connector 121. The second chamber 13 is delimited by opposite side walls each of which forms a carbon ribbon collection axle connector 131. The carbon ribbon axle connector 121 and the carbon ribbon collection axle connector 131 are both in operative coupling with a driving mechanism (not shown) of the barcode printer 200 to be driven by the barcode printer 200.

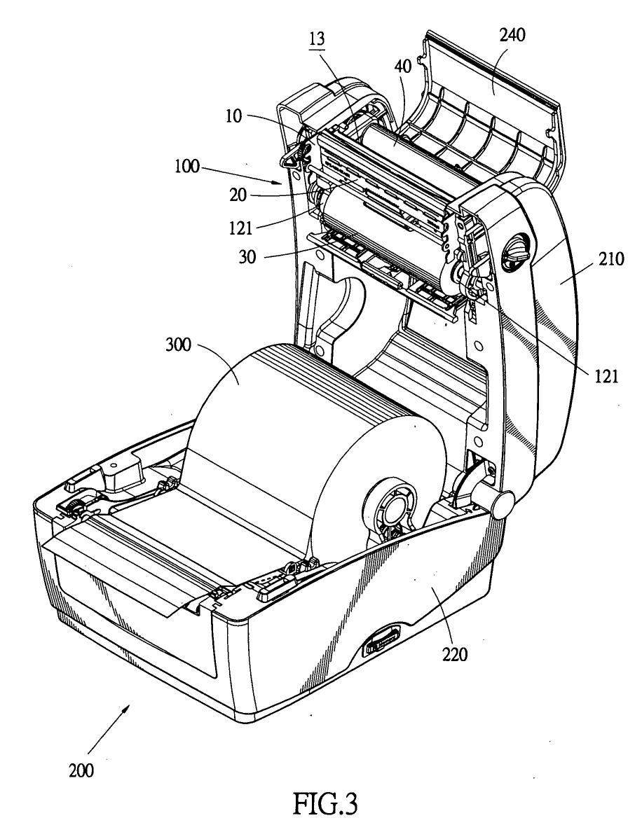

A printing head 20 is arranged at a location between the first chamber 12 and the second chamber 13. The printing head 20 functions to carry out printing on a barcode label 300 (see FIG. 3).

A carbon ribbon axle 30 is coupled to the carbon ribbon axle connectors 121 of the first chamber 12 of the slide rail 10, and thus, the carbon ribbon axle 30 is received in the first chamber 12, functioning to wind and store a carbon ribbon 400 that supplies toner required for printing operation of the barcode label 300 carried out by the printing head 20.

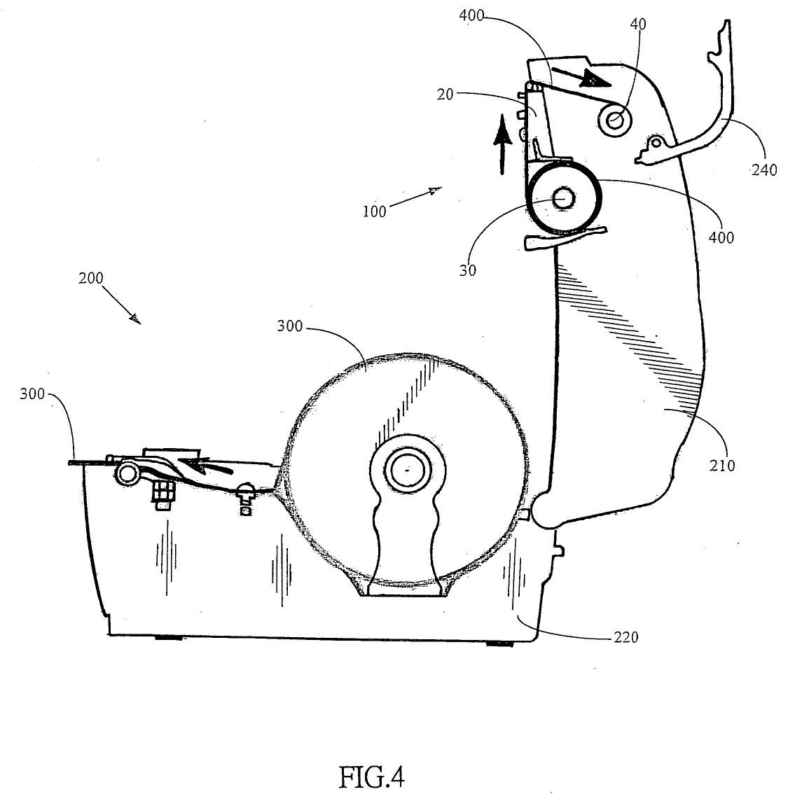

A carbon ribbon collection axle 40 is rotatably coupled to the carbon ribbon collection axle connectors 131 of the second chamber 13 of the slide rail 10 and thus, the carbon ribbon collection axle 40 is received in the second chamber 13 in an arrangement reversed to the carbon ribbon axle 30 for functioning to rewinding or rolling up and collecting the carbon ribbon 400 after the printing operation of the barcode label 300 is carried out by the printing head 20 (see FIG. 4).

Also referring to FIGS. 3 and 4, which demonstrate an application of the printing mechanism 100 in accordance with the present invention in a barcode printer 200, the barcode printer 200 has a lower casing member 220 in which label retainers 230 are provided for retaining the barcode label 300, preferably in the form of a roll. The upper casing member 210 of the barcode printer 200 is connected with a cover 240 for selectively closing the second chamber 13. The barcode label 300 is supplied from a front end of the lower casing member 220. When the upper casing member 210 is closed onto the lower casing member 220, the carbon ribbon 400 mounted on the carbon ribbon axle 30 supplies the toner that is needed for carrying out the printing operation of the barcode label 300. The barcode label 300, after having been printed by the printing head 20, is fed outward through the front end of the barcode label 300. The used carbon ribbon 400 that has been used to carry out the printing operation is forwarded into the second chamber 13 through the upper portion of the frame 10 to be rolled up and collected by the carbon ribbon collection axle 40 (as indicated by the arrows of FIG. 4). The carbon ribbon axle 30 and the carbon ribbon collection axle 40 define therebetween a shortest path for collecting the used carbon ribbon 400.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A printing mechanism for a barcode printer, comprising:
a frame, which is adapted to mount to an upper end portion of an upper casing member of the barcode printer, a first chamber being formed in lower portion of the frame, a second chamber being formed in an upper portion of the frame;
a printing head, which is positioned between the first and second chambers of the frame for effecting barcode label printing of the barcode printer;
a carbon ribbon axle, which is arranged in the first chamber for winding and storing a carbon ribbon that supplies toner for the barcode label printing effected by the printing head; and
a carbon ribbon collection axle, which is rotatably arranged in the second chamber in an arrangement reversed to the carbon ribbon axle for rolling up and collecting the carbon ribbon supplied from the carbon ribbon axle after the barcode label printing effected by the printing head.

2. The printing mechanism as claimed in claim 1, wherein the frame forms at least one pair of mounting holes.

3. The printing mechanism as claimed in claim 1, wherein opposite side walls of the first chamber of the frame each form a connector for the carbon ribbon axle.

4. The printing mechanism as claimed in claim 1, wherein opposite side walls of the second chamber of the frame each form a connector for the carbon ribbon collection axle.
